(19) United States
(12) Patent Application Publication
(10) Pub. No.: US 2010/0125585 A1
(43) Pub. Date: May 20, 2010

(54) Conjoint Analysis with Bilinear Regression Models for Segmented Predictive Content Ranking

(75) Inventors: Wei Chu, Sunnyvale, CA (US); Seung-Taek Park, San Jose, CA (US); Raghu Ramakrishnan, Los Altos, CA (US); Bee-Chung Chen, Mountain View, CA (US); Deepak K. Agarwal, Sunnyvale, CA (US); Pradheep Elango, Mountain View, CA (US); Scott Roy, Palo Alto, CA (US); Todd Beaupre, Sunnyvale, CA (US)

Correspondence Address: BAKER BOTTS L.L.P., 2001 ROSS AVENUE, 6TH FLOOR, DALLAS, TX, 75201, US

(73) Assignee: Yahoo! Inc., Sunnyvale, CA (US)

(21) Appl. No.: 12/272,607

(22) Filed: Nov. 17, 2008

(51) Int. Cl. G06F 17/30; G06F 7/06; G06F 7/00

(52) U.S. Cl. 707/748; 708/207; 707/E17.017; 707/E17.046

(57) ABSTRACT

Information with respect to users, items, and interactions between the users and items is collected. Each user is associated with a set of user features. Each item is associated with a set of item features. An expected score function is defined for each user-item pair, which represents an expected score a user assigns an item. An objective represents the difference between the expected score and the actual score a user assigns an item. The expected score function and the objective function share at least one common variable. The objective function is minimized to find best fit for some of the at least one common variable. Subsequently, the expected score function is used to calculate expected scores for individual users or clusters of users with respect to a set of items that have not received actual scores from the users. The set of items are ranked based on their expected scores.

### TECHNICAL FILED

Generally, the present disclosure relates to predictively ranking existing and new items for existing and new users. More specifically, the present disclosure relates to predictively ranking items each having one or more features for users each having one or more features by taking into consideration of the item features, the user features, and feedbacks the existing users given to the existing items. In some cases, the existing users are further clustered into segments based on their features and the feedbacks the existing users given to the existing items, which also constitutes a predictive mechanism. New users are classified into one of the segments based on their features and the predictive mechanism. A user will be served with the most popular article in the segment he or she belongs to.

### BACKGROUND

There are many situations where it is desirable or necessary to rank multiple items. Often, the ranking is performed for individuals or groups of individuals having similar preferences, such that the ranking of the items is personalized for each individual or each group of individuals to some degree to accommodate the fact that different people have different preferences.

Personalized ranking is very useful and beneficial to, for example, businesses conducting marketing and advertising of their products and/or services. Products and/or services are ranked based on various criteria, such as popularity, category, price range, etc., and the ranking of the products or services influences which products or services are selected for customer recommendation and in what order the recommendations are made.

A personalized service may not be exactly based on individual user behaviors. The content of a website can be tailored for a predefined audience, based on offline research of conjoint analysis, without online gathering knowledge on individuals for service. Conjoint analysis is one of the most popular market research methodologies for assessing how customers with heterogeneous preferences appraise various objective characteristics in products or services. Analysis of tradeoffs driven by heterogeneous preferences on benefits derived from product attributes provides critical inputs for many marketing decisions, e.g. optimal design of new products, target market selection, and pricing a product.

In a real-life example, Netflix, which is a business that mainly provides movie rentals to its members on the Internet, makes movie recommendations to individual members based on each member's past movie rental selections and other members' movie preferences and feedbacks. Each time a member logs into his/her Netflix account, he/she sees three or four movies selected for and recommended to him/her in various popular genres, such as Comedy, Drama, Action & Adventure, etc. Since there are hundreds of thousands of movies available at Netflix, some form of personalized ranking of the available movies is necessary in order to select those few top-ranked movies that a particular member is most likely to enjoy and thus rent. In this sense, the ranking is personalized for each individual member since the top-ranked movies for one member differ from the top-ranked movies for another member. Furthermore, the ranking is also predictive to a certain extent as the ranking algorithm attempts to anticipate which few movies among the hundreds of thousands of movies that a member has not seen that the member may want to rent based on that member's personal taste in movies.

Of course, ranking is not limited to products or services. Any type of item or object, such as music, images, videos, articles, news stories, etc., may be ranked. In another real-life example, Yahoo!®, an Internet portal and search engine, features news articles on its home page, referred to as “Yahoo!® Front Page.” FIG. 1 (prior art) illustrates a simplified Yahoo!® Front Page 100. The web page 100 is partitioned into several areas or components. Near the center, component 110 includes four tabs 121, 122, 123, 124. The first tab 121 is the “Featured” tab that includes four featured news articles 131, 132, 133, 134 for the current day. These four featured articles are selected from a pool of available articles. To do so, all the available articles are ranked based on some criteria, e.g. popularity, and the four top-ranked articles are selected as the four featured articles and presented in the “Featured” tab 121. Furthermore, the four top-ranked articles are presented in the order of their ranking. The highest ranked article 131 is presented in the first position, i.e., the most prominent position, as well as in the main position 140. The second highest ranked article 132 is presented in the second position. The third highest ranked article 133 is presented in the third position. And the fourth highest ranked article 134 is presented in the fourth position.

Currently, there are some personalized predictive ranking algorithms developed for ranking items such as products and/or services for marketing and advertising applications. Continuous efforts are being made to improve upon these ranking algorithms in terms of personalization, segmentation, efficiency, and/or prediction accuracy.

### SUMMARY

Broadly speaking, the present disclosure generally relates to predictively ranking new items for existing and new users and/or predictively ranking existing and new items for new users. The ranking is either personalized for individual users or for clusters of users.

According to various embodiments, item and user data have been collected using any means available, appropriate, and/or necessary. The collected data may be categorized into three groups: (1) data that represent user information; (2) data that represent item information; and (3) data that represent interactions between users and items.

Each user is associated with a set of user features, which may be represented using a user feature vector, \vec{U}. For a particular user, his/her feature values may be determined based on the collected data that represent the user information.

Each item is associated with a set of item features, which may be represented using an item feature vector, \vec{I}. For a particular item, its feature values may be determined based on the collected data that represent the item information.

For each user-item pair, the user features associated with the user and the item features associated with the item are merged by merging the user feature vector representing the user features and the item feature vector representing the item features into a single space. The merged user features and item features may be represented using a user-item merged feature vector.

An objective function is defined using a bilinear regression model that directly projects user features onto feature values aligned with item features with a regression coefficient vector. The regression coefficient vector that best fits the collected data and particularly the data that represent the interactions between the users and the items are determined.

Subsequently, the regression coefficient vector is used to predictively rank new items for users and/or items for new users. New items and new users refer to items and users where data representing interactions with the new items or from the new users have not been collected. The ranking may be personalized for individual users. Alternatively or in addition, users may be segmented into clusters, where each cluster of users has similar feature values. The ranking may then be personalized for individual clusters of users.

These and other features, aspects, and advantages of the disclosure are described in more detail below in the detailed description and in conjunction with the following figures.

### BRIEF DESCRIPTION OF THE DRAWINGS

The present disclosure is illustrated by way of example, and not by way of limitation, in the figures of the accompanying drawings and in which like reference numerals refer to similar elements and in which:

FIG. 1 (prior art) illustrates a web page that includes several components.

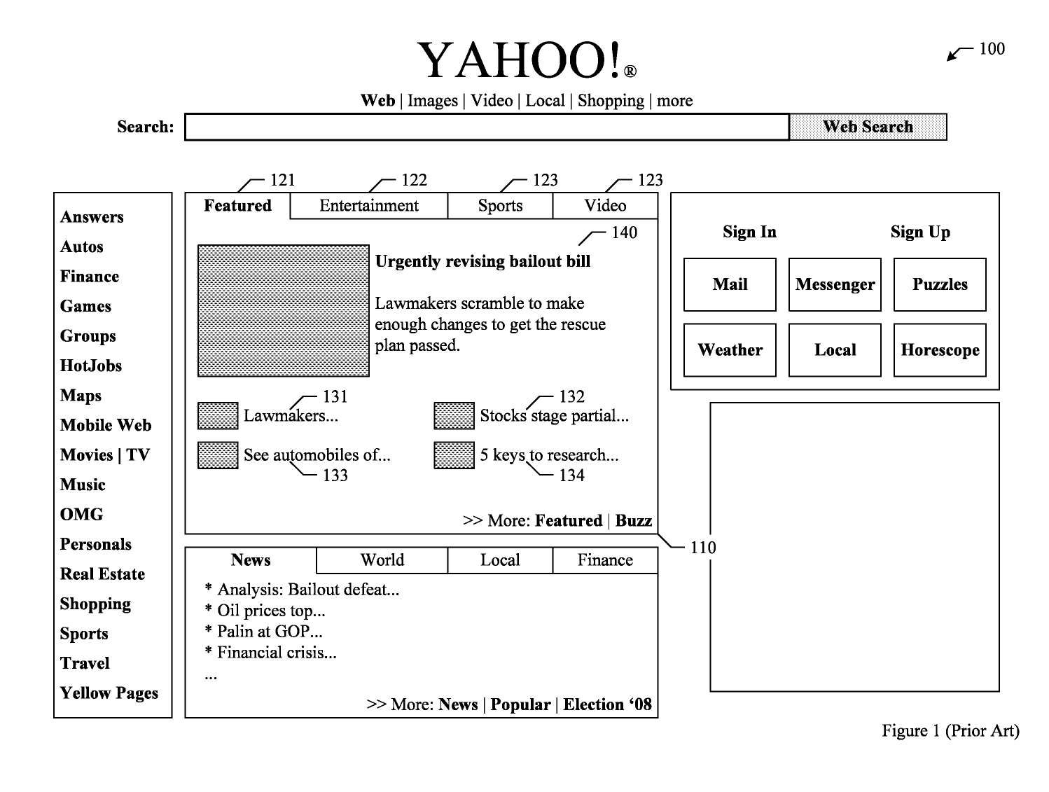

FIG. 2 illustrates a method of predictively ranking a set of items for individual users using a bilinear regression model according to an embodiment of the present disclosure.

FIG. 3 illustrates a method of predictively ranking a set of items for individual clusters of users using a bilinear regression model according to an embodiment of the present disclosure.

FIG. 4 illustrates four clusters of users segmented based on their preference similarities with respect to item features according to an embodiment of the present disclosure.

FIG. 5 illustrates a general computer system suitable for implementing embodiments of the present disclosure.

### DETAILED DESCRIPTION

The present disclosure is now described in detail with reference to a few preferred embodiments thereof as illustrated in the accompanying drawings. In the following description, numerous specific details are set forth in order to provide a thorough understanding of the present disclosure. It is apparent, however, to one skilled in the art, that the present disclosure may be practiced without some or all of these specific details. In other instances, well known process steps and/or structures have not been described in detail in order to not unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

Conjoint analysis, also referred to as multi-attribute compositional models or stated preference analysis, is a statistic analysis originated in mathematical psychology and is often used in marketing research and product management to assess how customers with heterogeneous preferences appraise various objective characteristics in products or services. In a typical scenario where conjoint analysis is performed on some product or service, research participants, e.g., users or customers, are asked to make a series of tradeoffs among various attributes or features of the product or service being analyzed. The analysis is usually carried out with some form of multiple regression, such as a hierarchical Bayesian model, and endeavors to unravel the values or partworths that the research participants place on the product's or the service's attributes or features. Conjoint analysis is also an analytical tool for predicting customers' plausible reactions to new products or services.

Traditional conjoint analysis usually involves a relatively small number of research participants being asked to make tradeoffs among a relatively small number of product attributes or features. One of the challenges in conjoint analysis is to obtain sufficient data from the research participants to estimate partworths at the individual level using relatively few questions. The size of data used in a traditional conjoint analysis usually has less than a thousand data points.

More recently, however, large sets of statistical and informational data have been collected using various means and especially in connection with the expansion of the Internet and electronic devices. It is not uncommon for people's activities to be monitored and tracked throughout the day and the data collected and stored for future analysis. Large data sets exist that include data relating to users, items or objects, user activities with respect to some items or objects, etc. These data sets often have millions of data points. Certain traditional conjoint analysis models, such as Monte Carlo simulation, are no longer suitable for handling such large data sets.

According to various embodiments of the present disclosure, a Bayesian technique that incorporates a bilinear regression model is used for conjoint analysis on very large data sets at individual-level partworths. The analysis may be performed for large data sets that include three types of data: (1) data that represent user information; (2) data that represent item information; and (3) data that represent interactions between users and items. The data may be collected using any means appropriate, suitable, or necessary. A set of data under analysis may be raw or may have been preprocessed, such as aggregated, categorized, etc. The user information may be represented as a set of user features, and thus, each user is associated with a set of user features. The item information may be represented as a set of item features, and thus, each item is associated with a set of item features. The interactions between the users and the items may be represented using various methods that are suitable for or appropriate to the types of interactions involved. The benefit of the present technique begins to show when a data set under analysis includes approximately two thousand user features and/or items features and increases as the size of the feature set increases, i.e. more user features, item features, and/or interactions between the users and the items.

A set of user features may include a user's demographic information and behavioral patterns and past activities. A user's demographic information may include age, gender, ethnicity, geographical location, education level, income bracket, profession, marital status, social networks, etc. A user's activities may include the user's Internet activities such as which web pages the user has viewed, what links in a web page the user has clicked, what search terms the user has entered at some Internet search engine, what products the user has viewed, rated, or purchased, to whom the user has sent emails or instant messages, which online social groups the user has visited, etc. The values of the user features for each individual user may be determined from the collected data that represent the user information.

Mathematically, a set of user features having m feature elements associated with a specific user, user i, may be expressed using a vector, denoted as \vec{U}ᵢ, where

\vec{U}ᵢ={u_{i,1},u_{i,2},u_{i,3}, . . . , u_{i,m}} (1)

The vector \vec{U}ᵢ has m elements corresponding to m user features. The individual user feature elements are denoted as u_{i,1}, u_{i,2}, u_{i,3}, . . . , u_{i,m}.

A set of item features may include static item features and dynamic item features. Typically, the values of the static item features remain unchanged, while the values of the dynamic item features vary from time to time. The static item features may include the item's category, sub-category, content, format, resource, keyword, etc. The dynamic item features may include the item's popularity, click through rate (CTR), etc. at a given time. Of course, an item's features often depend on the type of the specific item involved. Different types of items usually have different features. If the item under analysis is a MP3 player, its features may include the player's brand, storage capacity, battery life, audio quality, dimensions, etc. If the item is a book, its features may include the book's author, genre, publication date, publisher, ISBN, format, etc. If the item is a news article, its features may include the article's content, keywords, source, etc. If the item is a web page, its features may include the page's URL, CTR, content, keywords, metadata, etc. The values of the item features for each individual item may be determined from the collected data that represent the item information

Mathematically, a set of item features having n feature elements associated with a specific item, item j, may be expressed using a vector, denoted as \vec{I}ⱼ, where

\vec{I}ⱼ={i_{j,1},i_{j,2},i_{j,3}, . . . , i_{j,n}} (2)

The vector \vec{I}ⱼ has n elements corresponding to n item features. The individual item feature elements are denoted as i_{j,1}, i_{j,2}, i_{j,3}, . . . , i_{j,n}.

The interactions between the users and the items also vary depending on the types of items involved. A user interacts with different types of items differently. If an item is a product or a service, a user may review it, purchase it, rate it, comment on it, etc. If an item is a video, a user may view it, download it, rate it, recommend it to friends and associates, etc. If an item is a news article posed on the Internet, a user may click on it, read it, bookmark it in his/her browser, etc.

Most of these different types of interactions between a user and an item may be used to determine some form of feedback from the user to the item. The user feedback thus may be explicit or implicit. When a user rates on an item using any kind of rating system, it may be considered an explicit feedback. When a user purchases an item or recommend an item to his/her friends, it may be considered an implicit feedback that the user likes the item sufficiently to have made the purchase or recommendation.

Mathematically, the user feedbacks may be expressed using different notations depending on the forms of the feedbacks. According to some embodiments, there are three forms of user feedbacks. First, a user feedback may be continuous. This usually involves situations where a user is given an infinite number of ordered choices limited by a lower boundary and an upper boundary or without boundaries with respect to an item, and the user selects one of the choices. For example, a user may be asked to rate an item using a slider. The user may place the slider anywhere in the continuous range between a left end and a right end or between a top end and a bottom end. Thus, continuous feedbacks may be expressed as any real number.

Second, a user feedback may be binary. This usually involves situations where a user is given two choices with respect to an item, and the user selects one of the two choices. The choices and the selections may be implicit or explicit. For example, if the item is a product, the user may either purchase it or not purchase it. If the item is a video, the user may either view it or not view it, either rent it or not rent it, either download it or not download it, etc. If the item is a link in a web page, the user may either click it or not click it. If the item is an image or a book, the user may be asked to indicate whether he/she likes it or does not like it. Mathematically, a binary user feedback may be represented with two numbers, such as −1 and 1. Thus, binary feedbacks may be expressed as

{−1,1} (3)

Third, a user feedback may be ordinal. This usually involves situations where a user is given a finite number of ordered choices with respect to an item, and the user selects one of the available choices. For example, a user may be asked to rate an item using a star rating system, with five stars representing the highest rating and one star representing the lowest rating. Mathematically, an ordinal user feedback may be represented with a finite set of discrete numbers. Thus, ordinal feedbacks may be expressed as

{1,2,3,4, . . . , k} (4)

where k is the highest rank in the rating system.

The present analysis may be performed on any set of data that includes three categories of data: (1) user features; (2) item features; and (3) feedbacks from the users to the items. Again, an item may be any type of item that has some characteristic attributes or features. The present analysis may be used to predictively rank items for individual users and/or for clusters of similar users.

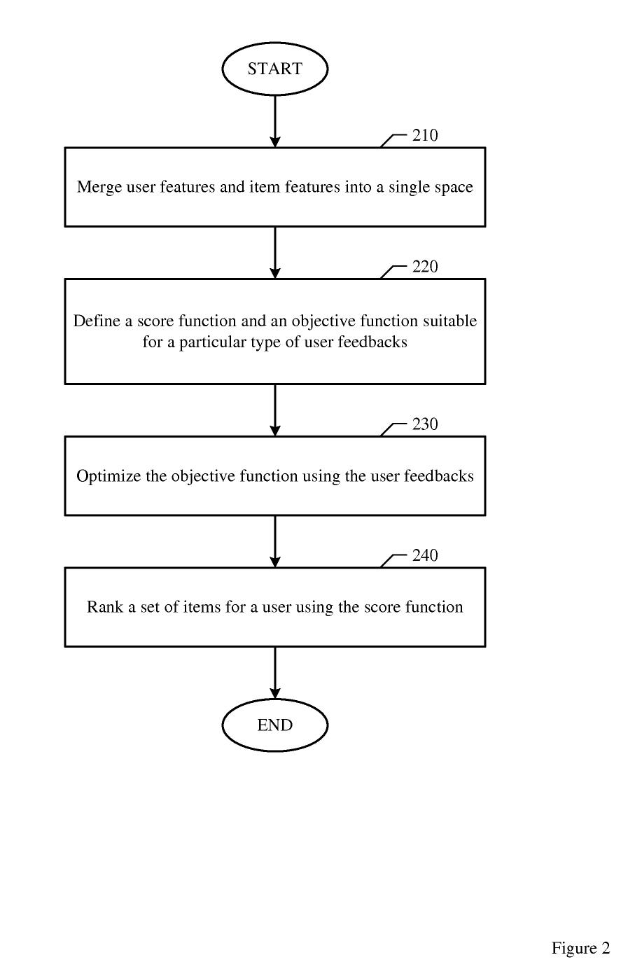

FIG. 2 illustrates a method of predictively ranking a set of items for individual users using a bilinear regression model according to an embodiment of the present disclosure. First, the user features and item features are merged into a single space (step 210). This may be achieved using different means, such as various types of vector operations. According to one embodiment, a user feature vector associated with user i, \vec{U}ᵢ and an item feature vector associated with item j, \vec{I}ⱼ, may be merged by taking their outer product, also referred to as their tensor product. Thus, for each user-item pair, user i and item j, if F_{i,j} denotes the merged \vec{U}ᵢ and \vec{I}ⱼ by outer product, then

$$\begin{matrix}{F}_{i , j} = {\vec{U}}_{i} ⊗ {\vec{I}}_{j} \\ = [ \begin{matrix}{u}_{i , 1} {i}_{j , 1} & {u}_{i , 1} {i}_{j , 2} & {u}_{i , 1} {i}_{j , 3} & … & {u}_{i , 1} {i}_{j , n} \\ {u}_{i , 2} {i}_{j , 1} & {u}_{i , 2} {i}_{j , 2} & {u}_{i , 2} {i}_{j , 3} & … & {u}_{i , 2} {i}_{j , n} \\ {u}_{i , 3} {i}_{j , 1} & {u}_{i , 3} {i}_{j , 2} & {u}_{i , 3} {i}_{j , 3} & … & {u}_{i , 3} {i}_{j , n} \\ … & … & … & … & … \\ {u}_{i , m} {i}_{j , 1} & {u}_{i , m} {i}_{j , 2} & {u}_{i , m} {i}_{j , 3} & … & {u}_{i , m} {i}_{j , n}\end{matrix} ]\end{matrix} \qquad ( 5 )$$

The vector \vec{U}ᵢ has m elements. The vector \vec{I}ⱼ has n elements. Therefore, F_{i,j} is a m×n matrix.

Alternatively, for computational purposes, the matrix F_{i,j} may be converted into a vector, denoted by \vec{F}_{i,j}, having m×n or mn elements, where

\vec{F}_{i,j}=\vec{U}ᵢ [symbol] \vec{I}ⱼ={u_{i,1}i_{j,1}, . . . u_{i,1}i_{j,n},u_{i,2}i_{j,1}, . . . i_{i,2}i_{j,n}, . . . i_{i,m}i_{j,1}, . . . u_{i,m}i_{j,n}} (6)

In this example, the vector \vec{U}ᵢ is an m by 1 vector, and the vector \vec{I}ⱼ is an n by 1 vector. Therefore, \vec{F}_{i,j} is a mn by 1 vector.

Next, a score function and an objective function suitable for a particular type of user feedbacks are defined (step 220). The score function for a user-item pair, denoted by S_{i,j}, represents an expected feedback score a user gives an item, which is a real number corresponding to a feedback the user gives the item.

An expected feedback score for each user-item pair, user i and item j, denoted by S_{i,j}, in terms of user features and item features may be expressed as

S_{i,j}=\vec{F}_{i,j}^{T}·\vec{W}+μᵢ+γⱼ (7)

where \vec{W} denotes the regression coefficient vector in a bilinear regression model and is an vector having mn elements; F_{i,j} denotes the merged user feature vector, \vec{U}ᵢ, and item feature vector, \vec{I}ⱼ, for user i and item j; μᵢ denotes individual user-specific feature offset for user i; and γⱼ denotes individual item-specific feature offset for item j. For example, a particular user may give the same feedback to all items regardless of his/her true opinions toward each individual item or a particular user may be more generous than other users on rating. Such bias in a particular user may be compensated, i.e., offset, with μᵢ. Similarly, a particular item may be extremely popular or unpopular that all users give positive or negative feedbacks. Such bias in a particular item may be compensated, i.e., offset, with γⱼ.

Mathematically, the term \vec{F}_{i,j}^{T}·\vec{W} in Equation (7) is equivalent to

$${\sum }_{b = 1}^{n} {\sum }_{a = 1}^{m} {\vec{W}}_{ab} {u}_{i , a} {i}_{j , b} ,$$

where u_{i,a} is a feature of the user i and i_{j,b} bis a feature of item j, and \vec{W}_{ab} is the regression coefficient on the fused feature u_{i,a}i_{j,b}. Thus, the expected feedback score function, S_{i,j}, may be directly expressed in terms of the user feature vector, \vec{U}ᵢ, and the item feature vector, \vec{I}ⱼ as

$$\begin{matrix}{S}_{i , j} = {\sum }_{b = 1}^{n} {\sum }_{a = 1}^{m} {\vec{W}}_{ab} {u}_{i , a} {i}_{j , b} + {μ}_{i} + {γ}_{j} \\ = {\sum }_{b = 1}^{n} {\hat{u}}_{i , b} {i}_{j , b} + {μ}_{i} + {γ}_{j}\end{matrix} \qquad ( 8 )$$

where

$${\hat{u}}_{i , b} = {\sum }_{a = 1}^{m} {\vec{W}}_{ab} {u}_{i , a}$$

represents user i's preference on the feature i_{j,b}.

An actual feedback the user gives the item is the target, which is denoted by S̅_{i,j}. For different forms of user feedbacks, the target, S̅_{i,j}, may be different. For continuous feedbacks, the targets may be any real number. For binary feedbacks, the targets may be either −1 or 1. And for ordinal feedbacks, the targets may be 1, 2, 3, . . . , k.

The objective function, denoted by O, incorporates the user features and the item features and compares the expected scores with the actual feedbacks users give to items. Again, different types of objective functions may be defined to express different forms of user feedbacks.

Once an appropriate score function and objective function are defined for a particular type of user feedbacks, the objective function may be optimized using a suitable algorithm or technique (step 230). The method of model optimization depends on the form of user feedbacks and the form of objective function under analysis.

Finally, based on the optimized model, a set of items may be ranked for individual users using the expected score function, S_{i,j} (step 240). Because different forms of user feedbacks require different analytical models, e.g., expected score functions and objective functions, steps 220, 230, and 240 are described in more detail below with respect to selected forms of user feedbacks, i.e., continuous and binary.

### Continuous User Feedbacks

According to one embodiment, with continuous user feedbacks, a user may give any real number. An expected score function for each user-item pair, user i and item j, denoted by S_{i,j}, is expressed as in Equation (8). The difference between feedbacks and expected scores for all user-item pairs may be calculated as

$${\sum }_{\{ {\overline{S}}_{i , j} \}} {( {\overline{S}}_{i , j} - {S}_{i , j} )}^{2} \qquad ( 9 )$$

Using the bilinear regression model, the objective function, denoted by O, is expressed as

$$O = \frac{1}{2} {\sum }_{\{ {\overline{S}}_{i , j} \}} \{ {( {\overline{S}}_{i , j} - {S}_{i , j} )}^{2} + \frac{α}{2} {\vec{W}}^{T} \vec{W} \} \qquad ( 10 )$$

where S̅_{i,j} denotes the actual score determined based on the continuous user feedbacks from the collected data, \vec{W}^{T} denotes a transpose of \vec{W}, and a is a tradeoff between the distance and the complexity of \vec{W}.

The objective function, O, is optimized by finding a best fit for the regression coefficient vector, \vec{W}, based on the collected continuous user feedback data. In other words, the regression coefficient vector, \vec{W}, is solved using the objective function O with respect to the collected user feedback data. One way to achieve this is to begin by assigning default values to all the unknown terms in the objective function, including \vec{W}, μᵢ, and γⱼ. For example, initially, the unknown terms may be assigned a value 0. Next, an expected score, S_{i,j}, is calculated using the objective function and actual user feature values and item features values determined from the collected data. The calculated score is compared with the actual score, S̅_{i,j}. Based on the difference between the calculated score, S_{i,j}, and the actual score, S̅_{i,j}, the values of \vec{W}, μᵢ, and γⱼ are adjusted accordingly in order to bring the calculated score, S_{i,j}, closer to the actual score, S_{i,j}. This process may be repeated for multiple iterations, until a best fit for \vec{W}, μᵢ, and γⱼ are found, i.e., values that bring the objective functional O to the minimum.

With respect to the object function, O, defined in Equation (10), the direction that the values of \vec{W}, μᵢ, and γⱼ move is indicated by the first order partial derivate of the equation. Thus, the direction of the regression coefficient vector, \vec{W}, is

$$\frac{\partial O}{\partial \vec{W}} = {\sum }_{\{ {\overline{S}}_{i , j} \}} \{ ( {S}_{i , j} - {\overline{S}}_{i , j} ) {\vec{F}}_{i , j} + α \vec{W} \} \qquad ( 11 )$$

The direction of μᵢ is

$$\frac{\partial O}{\partial {μ}_{i}} = {\sum }_{\{ {\overline{S}}_{i , \cdot } \}} \{ {S}_{i , j} - {\overline{S}}_{i , j} \} \qquad ( 12 )$$

where { S̅_{i,j}} denotes the set of feedbacks associated with user i.

The direction of γⱼ is

$$\frac{\partial O}{\partial {γ}_{j}} = {\sum }_{\{ {\overline{S}}_{\cdot , j} \}} \{ {S}_{i , j} - {\overline{S}}_{i , j} \} \qquad ( 13 )$$

where { S̅_{i,j}} denotes the set of feedbacks associated with item j.

### Binary User Feedbacks

According to one embodiment, with binary user feedbacks, as expressed with Equation (3), a score function that calculates the expected score for a user-item pair may be a logistic function. A user may give an item a score of either −1 or 1. For each user-item pair, user i and item j, if S_{i,j} denotes the score function for binary user feedbacks, then

$$p ( {\overline{S}}_{i , j} ) = \frac{1}{1 + {e}^{- {S}_{i , j} {S}_{i , j}}} \qquad ( 14 )$$

In Equation (14), the score function, S_{i,j} is defined as in Equation (8) that fuses user and item features through the regression coefficient vector \vec{W}. The probability, p, evaluates the correspondence between the score function S_{i,j} and the actual binary feedback S̅_{i,j}.

According to one embodiment, with binary user feedbacks, if O denotes the objective function, then

$$O = {\sum }_{\{ {\overline{S}}_{i , j} \}} \{ log ( 1 + {e}^{- {\overline{S}}_{i , j} {S}_{i , j}} ) + \frac{α}{2} {\vec{W}}^{T} \vec{W} \} \qquad ( 15 )$$

With respect to the object function, O, defined in Equation (15), the direction that the values of \vec{W}, μᵢ, and γⱼ move is indicated by the first order partial derivate of the equation. Thus, the direction of the regression coefficient vector, \vec{W}, is

$$\frac{\partial O}{\partial \vec{W}} = {\sum }_{\{ {\overline{S}}_{i , j} \}} \{ \frac{- {\overline{S}}_{i , j} {e}^{- {\overline{S}}_{i , j} {S}_{i , j}}}{1 + {e}^{- {\overline{S}}_{i , j} {S}_{i , j}}} {F}_{i , j} + α \vec{W} \} \qquad ( 16 )$$

The direction of μᵢ is

$$\frac{\partial O}{\partial {μ}_{i}} = {\sum }_{\{ {\overline{S}}_{i , \cdot } \}} \{ \frac{- {\overline{S}}_{i , j} {e}^{- {\overline{S}}_{i , j} {S}_{i , j}}}{1 + {e}^{- {\overline{S}}_{i , j} {S}_{i , j}}} \} \qquad ( 17 )$$

where { S̅hd i,j} denotes the set of feedbacks associated with user i.

The direction of γⱼ is

$$\frac{\partial O}{\partial {γ}_{j}} = {\sum }_{\{ {\overline{S}}_{\cdot , j} \}} \{ \frac{- {\overline{S}}_{i , j} {e}^{- {\overline{S}}_{i , j} {S}_{i , j}}}{1 + {e}^{- {\overline{S}}_{i , j} {S}_{i , j}}} \} \qquad ( 18 )$$

where { S̅_{i,j}} denotes the set of feedbacks associated with item j.

A different score function and objective function may be defined for ordinal user feedbacks, and the same concept described above for the continuous and binary user feedbacks may apply to the ordinal user feedbacks.

Once a best fit is found for \vec{W}, μᵢ, and γⱼ, Equations (7) or (8) may be used to calculate expected scores for items that have not received user feedbacks from specific users, i.e., new items, for those users. In this sense, the expected scores are personalized for each individual user based on each user's user feature values. In other words, in Equations (7) or (8), the expected score, S_{i,j}, is calculated for specific user-item pairs. Subsequently, a set of new items may be ranked based on their expected scores for each individual user.

More specifically, given a particular user, user i, who is associated with a user feature vector, \vec{U}ᵢ, and a set of items, item 1 to item n, each of which is associated with an item feature vector, \vec{I}₁ to Īₙ, by repeatedly applying Equations (7) or (8) for user i with each of the items in the set, a set of n expected scores, S_{i,1} to S_{i,n}, may be obtained corresponding to the n items. Note that a different item feature vector is used each time to calculate the expected score that that particular item. The n expected scores, S_{i,1} to S_{i,n}, are then used to rank the n items for user i.

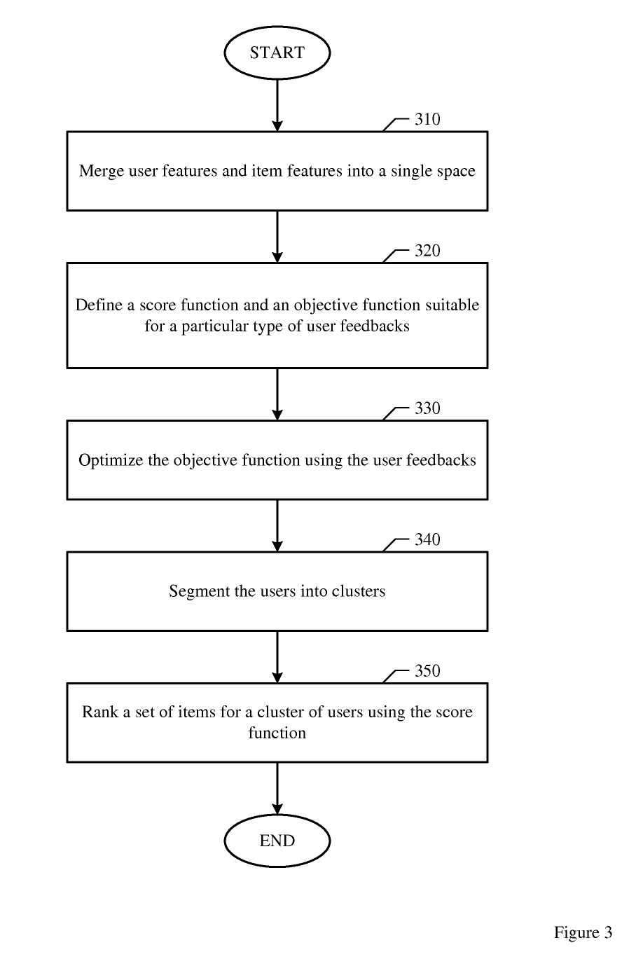

Alternatively, instead of personalized ranking for individual users, the ranking may be personalized for a group of similar users. The similarities among the users may be chosen based on different criteria. For example, users may be segmented based on similar preferences with respect to items, etc. FIG. 3 illustrates a method of predictively ranking a set of items for individual clusters of users using a bilinear regression model according to an embodiment of the present disclosure. Steps 310, 320, and 330 in FIG. 3 are exactly the same as steps 210, 220, and 230 in FIG. 2 respectively, i.e., defining user features, item features, user feedbacks with respect to items, and objective functions for each form of user feedbacks, and optimizing the objective functions.

Once the best fit has been determined for the various variables in the objective functions, instead of ranking items for individual users, the users are first segmented into one or more clusters (step 340). Any type of clustering algorithm may be used to segment the users. According to one embodiment, the users may be segmented based on their preferences with respect to item features, i.e. û_{i,b} as in Equation (8). That is, users with similar preferences to item features are clustered together.

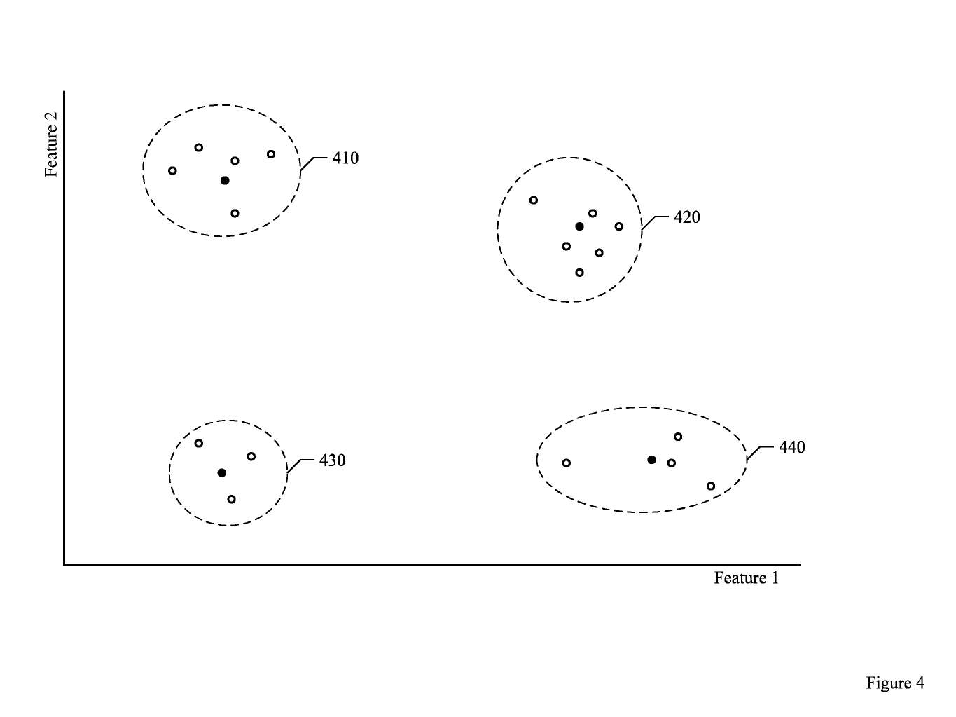

FIG. 4 illustrates four clusters of users segmented based on their preference similarities with respect to item features according to an embodiment of the present disclosure. To simplify the discussion, FIG. 4 only includes two item features, Feature 1 and Feature 2. Each user is positioned in the two-dimensional space based on his/her preference of these two item features. Of course, in practice, the number of item features is much greater, such as hundreds or thousands of item features. The same concept as illustrated in FIG. 4 may then be extended to higher dimensions accordingly.

As illustrated in FIG. 4, users with similar preferences toward item features cluster together. In FIG. 4, there are four clusters 410, 420, 430, 440. Again, in practice, there is no limit on the number of clusters into which the users may be segmented. According to one embodiment, the analysis may pre-define a desirable cluster number. According to another embodiment, the number of clusters may be determined based on the user preferences.

Once the users are segmented into clusters, a representative user feature vector may be determined for each cluster of users. The values of the user features in the representative vector may be calculated using different methods, such as taking averages of the feature values of all the users in the cluster, taking the feature values of the user in the middle of the cluster, etc. Alternatively, the popularity of items within segments respectively, e.g. estimate click through rate (CTR) of available items in each segment, may be monitored and then the items may be ranked for a user based on item popularity within the segment which the user belongs to.

Subsequently, a set of new items, i.e., items that have not received any user feedbacks from a particular cluster of users, may be ranked for the cluster of users (step 350). The ranking is similar to step 240 of FIG. 2, except that instead of using a user feature vector associated with a particular user, a representative user feature vector associated with a specific cluster is used. This way, the expected criteria calculated for the items are personalized for the cluster instead of for the individual users. Consequently, as the expected criteria are used to rank the items, the ranking is personalized for the cluster.

Segmenting users into clusters may lighten the overhead or processing power. The items are ranked for groups of users instead of individual users, which lessen the demand on computational resources. This is especially beneficial for online applications where thousands or millions of users are involved in the space of user preferences on item features.

The method illustrated in FIG. 2 may be used to predictively rank items for individual users. The method illustrated in FIG. 3 may be used to predictively rank items for individual clusters of users. Typically, the items to be ranked are items that have not received feedbacks from the user or the cluster of users for whom the ranking is conducted. In this sense, the items may be considered as “new” items only to the particular user or the particular cluster of users, even though the items may have received feedbacks from other users.

With the method illustrated in FIG. 3, if a user who has not been segmented into any cluster appears, the user is segmented to the appropriate cluster first. This may be achieved using various methods. For example, the user may be compared with the user at approximately the center of each cluster to determine to which cluster the user belongs.

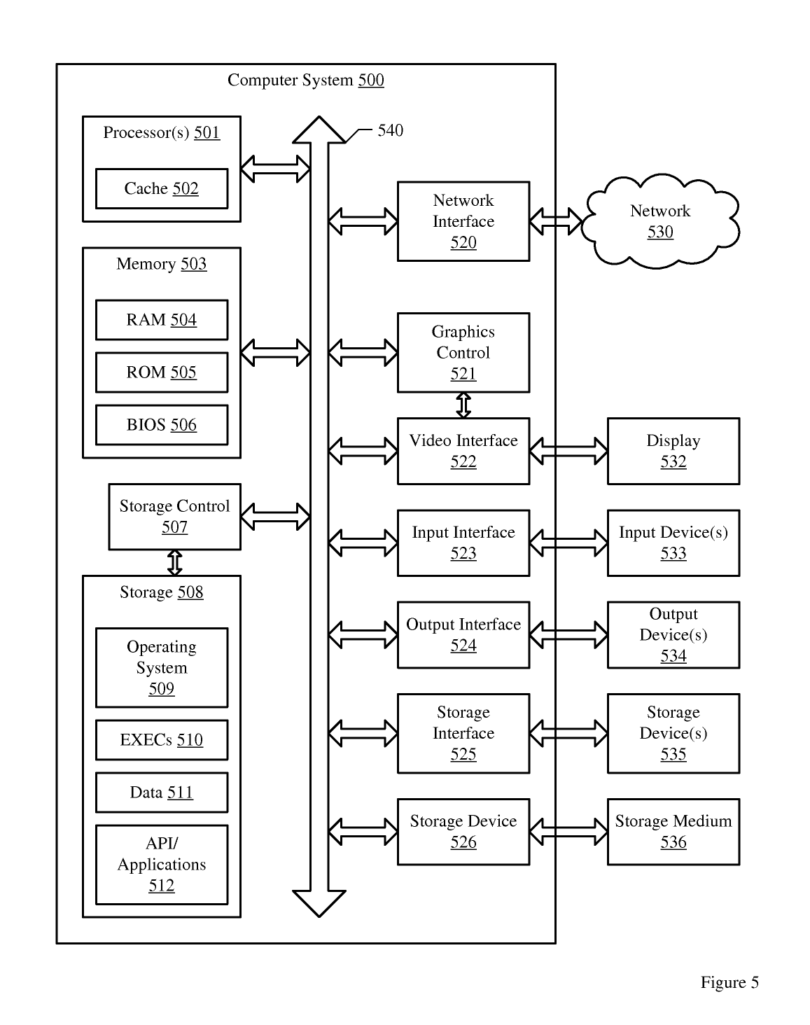

The methods illustrated in FIGS. 2 and 3 may be implemented as computer software using computer-readable instructions and stored in computer-readable medium. The software instructions may be executed on various types of computers. For example, FIG. 5 illustrates a computer system 500 suitable for implementing embodiments of the present disclosure. The components shown in FIG. 5 for computer system 500 are exemplary in nature and are not intended to suggest any limitation as to the scope of use or functionality of the API. Neither should the configuration of components be interpreted as having any dependency or requirement relating to any one or combination of components illustrated in the exemplary embodiment of a computer system. The computer system 500 may have many physical forms including an integrated circuit, a printed circuit board, a small handheld device (such as a mobile telephone or PDA), a personal computer or a super computer.

Computer system 500 includes a display 532, one or more input devices 533 (e.g., keypad, keyboard, mouse, stylus, etc.), one or more output devices 534 (e.g., speaker), one or more storage devices 535, various types of storage medium 536.

The system bus 540 link a wide variety of subsystems. As understood by those skilled in the art, a “bus” refers to a plurality of digital signal lines serving a common function. The system bus 540 may be any of several types of bus structures including a memory bus, a peripheral bus, and a local bus using any of a variety of bus architectures. By way of example and not limitation, such architectures include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

Processor(s) 501 (also referred to as central processing units, or CPUs) optionally contain a cache memory unit 502 for temporary local storage of instructions, data, or computer addresses. Processor(s) 501 are coupled to storage devices including memory 503. Memory 503 includes random access memory (RAM) 504 and read-only memory (ROM) 505. As is well known in the art, ROM 505 acts to transfer data and instructions uni-directionally to the processor(s) 501, and RAM 504 is used typically to transfer data and instructions in a bi-directional manner. Both of these types of memories may include any suitable of the computer-readable media described below.

A fixed storage 508 is also coupled bi-directionally to the processor(s) 501, optionally via a storage control unit 507. It provides additional data storage capacity and may also include any of the computer-readable media described below. Storage 508 may be used to store operating system 509, EXECs 510, application programs 512, data 511 and the like and is typically a secondary storage medium (such as a hard disk) that is slower than primary storage. It should be appreciated that the information retained within storage 508, may, in appropriate cases, be incorporated in standard fashion as virtual memory in memory 503.

Processor(s) 501 is also coupled to a variety of interfaces such as graphics control 521, video interface 522, input interface 523, output interface, storage interface, and these interfaces in turn are coupled to the appropriate devices. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. Processor(s) 501 may be coupled to another computer or telecommunications network 530 using network interface 520. With such a network interface 520, it is contemplated that the CPU 501 might receive information from the network 530, or might output information to the network in the course of performing the above-described method steps. Furthermore, method embodiments of the present disclosure may execute solely upon CPU 501 or may execute over a network 530 such as the Internet in conjunction with a remote CPU 501 that shares a portion of the processing.

In addition, embodiments of the present disclosure further relate to computer storage products with a computer-readable medium that have computer code thereon for performing various computer-implemented operations. The media and computer code may be those specially designed and constructed for the purposes of the present disclosure, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

As an example and not by way of limitation, the computer system having architecture 500 may provide functionality as a result of processor(s) 501 executing software embodied in one or more tangible, computer-readable media, such as memory 503. The software implementing various embodiments of the present disclosure may be stored in memory 503 and executed by processor(s) 501. A computer-readable medium may include one or more memory devices, according to particular needs. Memory 503 may read the software from one or more other computer-readable media, such as mass storage device(s) 535 or from one or more other sources via communication interface. The software may cause processor(s) 501 to execute particular processes or particular steps of particular processes described herein, including defining data structures stored in memory 503 and modifying such data structures according to the processes defined by the software. In addition or as an alternative, the computer system may provide functionality as a result of logic hardwired or otherwise embodied in a circuit, which may operate in place of or together with software to execute particular processes or particular steps of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

While this disclosure has described several preferred embodiments, there are alterations, permutations, and various substitute equivalents, which fall within the scope of this disclosure. It should also be noted that there are many alternative ways of implementing the methods and apparatuses of the present disclosure. It is therefore intended that the following appended claims be interpreted as including all such alterations, permutations, and various substitute equivalents as fall within the true spirit and scope of the present disclosure.

What is claimed is:

1. A method, comprising:
defining an expected score function, S_{i,j}, for a user-item pair, wherein the expected score function, S_{i,j}, represents an expected score a user, user i, assigns an item, item j;
defining an objective function, O, wherein the objective function indicates a difference between the expected score, S_{i,j}, and an actual score, S̅_{i,j}, a user, user i, assigns an item, item j, and wherein the expected score function, S_{i,j}, and the objective function, O, comprise at least one common variable;
minimizing the objective function to find best fit for selected ones of the at least one common variable;
calculating an expected score for each of a set of items using the expected score function, S_{i,j} with the best fit for the selected ones of the at least one common variable for a user, wherein the user has not assigned actual scores to the set of items; and
ranking the set of items for the user based on each item's expected score.

2. A method as recited in claim 1, wherein each user is associated with a set of user features represented by a user feature vector, \vec{U}ᵢ, each item is associated with a set of item features represented by an item feature vector, \vec{I}ⱼ, and the expected score function, S_{i,j}, and the objective function, O, each comprises the user feature vector, \vec{U}ᵢ, and the item feature vector, \vec{I}ⱼ.

3. A method as recited in claim 1, wherein the expected score function, S_{i,j}, and the objective function, O, are defined according to a form of score system used for a user to assign a score to an item.

4. A method as recited in claim 3, wherein the form of score system is a continuous score system, the score function, S_{i,j}, and the objective function, O, are based on a bilinear regression model, and the at least one common variable comprises a regression coefficient vector, \vec{W}.

5. A method as recited in claim 1, wherein finding best fit for a common variable comprised in both the expected score function, S_{i,j}, and the objective function, O, comprises:
assigning default values to elements in the common variable; and
repeatedly adjusting the values of the elements in the common variable to minimize the objective function, O.

6. A method as recited in claim 5, wherein a direction to adjust the values of the elements in the common variable is indicated by a first order partial derivative of the objective function, O, with respect to the common variable.

7. A method, comprising:
defining an expected score function, S_{i,j}, for a user-item pair, wherein the expected score function, S_{i,j}, represents an expected score a user, user i, assigns an item, item j;
defining an objective function, O, wherein the objective function indicates a difference between the expected score, S_{i,j}, and an actual score, S̅_{i,j}, a user, user i, assigns an item, item j, and wherein the expected score function, S_{i,j}, and the objective function, O, comprise at least one common variable;
minimizing the objective function to find best fit for selected ones of the at least one common variable;
segmenting a set of users into a plurality of user clusters, wherein each user cluster comprises at least one user from the set of users;
calculating an expected score for each of a set of items using the expected score function, S_{i,j}, with the best fit for the selected ones of the at least one common variable for one of the plurality of user clusters, wherein the users in the user cluster has not assigned actual scores to the set of items; and
ranking the set of items for the user cluster based on each item's expected score.

8. A method as recited in claim 7, wherein each user is associated with a set of user features represented by a user feature vector, \vec{U}ᵢ, each item is associated with a set of item features represented by an item feature vector, \vec{I}ⱼ, and the expected score function, S_{i,j}, and the objective function, O, each comprises the user feature vector, \vec{U}ᵢ, and the item feature vector, \vec{I}ⱼ.

9. A method as recited in claim 8, wherein segmenting the set of users into the plurality of user clusters according to the users' preferences with respect to item features such that users having similar preferences with respect to item features are segmented into a same user cluster.

10. A method as recited in claim 7, wherein the expected score function, S_{i,j}, and the objective function, O, are defined according to a form of score system used for a user to assign a score to an item.

11. A method as recited in claim 7, wherein finding best fit for a common variable comprised in both the expected score function, S_{i,j}, and the objective function, O, comprises:
assigning default values to elements in the common variable; and
repeatedly adjusting the values of the elements in the common variable to minimize the objective function, O.

12. A method as recited in claim 11, wherein a direction to adjust the values of the elements in the common variable is indicated by a first order partial derivative of the objective function, O, with respect to the common variable.

13. A computer program product comprising a computer-readable medium having a plurality of computer program instructions stored therein, which are operable to cause at least one computing device to:
define an expected score function, S_{i,j}, for a user-item pair, wherein the expected score function, S_{i,j}, represents an expected score a user, user i, assigns an item, item j;
define an objective function, O, wherein the objective function indicates a difference between the expected score, S_{i,j}, and an actual score, S̅_{i,j}, a user, user i, assigns an item, item j, and wherein the expected score function, S_{i,j}, and the objective function, O, comprise at least one common variable;
minimize the objective function to find best fit for selected ones of the at least one common variable;
calculate an expected score for each of a set of items using the expected score function, S_{i,j}, with the best fit for the selected ones of the at least one common variable for a user, wherein the user has not assigned actual scores to the set of items; and
rank the set of items for the user based on each item's expected score.

14. A computer program product as recited in claim 13, wherein the expected score function, S_{i,j}, and the objective function, O, are defined according to a form of score system used for a user to assign a score to an item.

15. A computer program product as recited in claim 13, wherein finding best fit for a common variable comprised in both the expected score function, S_{i,j}, and the objective function, O, comprises:
assigning default values to elements in the common variable; and
repeatedly adjusting the values of the elements in the common variable to minimize the objective function, O.

16. A computer program product as recited in claim 15, wherein a direction to adjust the values of the elements in the common variable is indicated by a first order partial derivative of the objective function, O, with respect to the common variable.

17. A computer program product comprising a computer-readable medium having a plurality of computer program instructions stored therein, which are operable to cause at least one computing device to:
define an expected score function, S_{i,j}, for a user-item pair, wherein the expected score function, S_{i,j} represents an expected score a user, user i, assigns an item, item j;
define an objective function, O, wherein the objective function indicates a difference between the expected score, S_{i,j}, and an actual score, S̅_{i,j}, a user, user i, assigns an item, item j, and wherein the expected score function, S_{i,j}, and the objective function, O, comprise at least one common variable;
minimize the objective function to find best fit for selected ones of the at least one common variable;
segment a set of users into a plurality of user clusters, wherein each user cluster comprises at least one user from the set of users;
calculate an expected score for each of a set of items using the expected score function, S_{i,j} with the best fit for the selected ones of the at least one common variable for one of the plurality of user clusters, wherein the users in the user cluster has not assigned actual scores to the set of items; and
rank the set of items for the user cluster based on each item's expected score.

18. A computer program product as recited in claim 17, wherein each user is associated with a set of user features represented by a user feature vector, \vec{U}ᵢ, each item is associated with a set of item features represented by an item feature vector, \vec{I}ⱼ, and the expected score function, S_{i,j}, and the objective function, O, each comprises the user feature vector, \vec{U}ᵢ, and the item feature vector, \vec{I}ⱼ.

19. A computer program product as recited in claim 18, wherein segmenting the set of users into the plurality of user clusters according to the users' preferences with respect to item features such that users having similar preferences with respect to item features are segmented into a same user cluster.

20. A computer program product as recited in claim 17, wherein finding best fit for a common variable comprised in both the expected score function, S_{i,j}, and the objective function, O, comprises:
assigning default values to elements in the common variable; and
repeatedly adjusting the values of the elements in the common variable to minimize the objective function, O.
